(19) United States
(12) Patent Application Publication
(10) Pub. No.: US 2019/0197527 A1
(43) Pub. Date: Jun. 27, 2019

(54) METHOD AND SYSTEM FOR FACILITATING DIGITAL WALLET BASED PAYMENT CARD TRANSACTIONS

(71) Applicant: Mastercard International Incorporated, Purchase, NY (US)

(72) Inventors: Sachin Kumar Agarwalla, Pune (IN); Shweta Gupta, Pune (IN); Ankit Kothari, Pune (IN)

(73) Assignee: Mastercard International Incorporated, Purchase, NY (US)

(21) Appl. No.: 16/178,668

(22) Filed: Nov. 2, 2018

(30) Foreign Application Priority Data
Dec. 21, 2017 (SG) 10201710682V

(51) Int. Cl. G06Q 20/36

(52) U.S. Cl. CPC G06Q 20/363; G06Q 20/3674

(57) ABSTRACT

A method and system for facilitating digital wallet based payment card transactions is provided. A server system associated with a payment network receives payment card information provided by a user to an online merchant in relation to online purchase transaction. The payment card information is associated with user consent to add a corresponding payment card to a digital wallet account. The server system creates a digital wallet account and adds the payment card to the digital wallet account if no record of the digital wallet account for the user exists at the server system. The server system adds the payment card to the digital wallet account using the payment card information if a record of the digital wallet account for the user exists at the server system. The server system facilitates processing of payment for the online purchase transaction based on the payment card information associated with the payment card.

### CROSS REFERENCE TO RELATED APPLICATIONS

This application claims priority to Singaporean Application Serial No. 10201710682V, filed Dec. 21, 2017, which is incorporated herein by reference in its entirety

### TECHNICAL FIELD

The present disclosure relates to financial transactions, and more particularly, to a method and system for facilitating digital wallet based payment card transactions.

### BACKGROUND

Digital wallets, also known as electronic wallets, enable users to store all their banking card and shipping information in a secure location. The stored information may be used for performing purchase transactions during online shopping for instance. Storing banking card and shipping information in one secure location provides several benefits to the users. For example, a user does not have to physically possess a banking card to engage in a purchase transaction. The banking card details of one or more banking cards stored in the digital wallet may be instantly retrieved by the user during an ongoing online purchase transaction, thereby making it very convenient for the user to choose a banking card for the online purchase transaction. Further, the user is saved the effort of entering banking card and shipping information in various form fields displayed on the Website for completing the online purchase transaction, thereby enabling the user to check out faster.

Currently, the users have to intentionally visit a Website or an online portal of a digital wallet service provider to sign-up and create an account. The users may then add respective banking card and shipping information to their account. This step of deliberately creating an account may put off users from using the digital wallet service. Furthermore, in some example scenarios, if a user does not want to use a banking card included within a digital wallet for an ongoing online purchase transaction, then the user has to login to the digital wallet account and add a new banking card to the account to use the new banking card for the ongoing online purchase transaction. This may be cumbersome for the user and the user may abandon the online purchase transaction altogether. Such aforementioned factors hinder the widespread usage of digital wallets in performing purchase transactions in spite of the several benefits offered by the digital wallets. Accordingly, there is a need to facilitate digital wallet based payment transactions while precluding cumbersome effort on part of the users.

### SUMMARY

Various embodiments of the present disclosure provide methods and system for digital wallet based payment card transactions.

In one embodiment, a method for facilitating digital wallet based payment card transactions is disclosed. The method receives, by a server system of a payment network, payment card information provided by a user to an online merchant in relation to online purchase transaction. The payment card information is associated with consent from the user to add a corresponding payment card to a digital wallet account. The method performs, by the server system, one of: (1) creating the digital wallet account for the user if no record of the digital wallet account for the user exists at the server system and adding the payment card to the digital wallet account created for the user, and (2) adding the payment card to the digital wallet account if a record of the digital wallet account for the user exists at the server system. The payment card is added to the digital wallet account using the payment card information. The method facilitates, by the server system, processing of payment for the online purchase transaction based on the payment card information associated with the payment card.

In one embodiment, a server system configured to facilitate digital wallet based payment card transactions is disclosed. The server system is associated with a payment network and includes a database and a computer system in operative communication with the database. The database is configured to store digital wallet accounts for a plurality of users. Each digital wallet account includes information related to one or more payment cards associated with a respective user. Each payment card from among the one or more payment cards is capable of facilitating at least one financial transaction. The computer system includes a communication interface and a processor in operative communication with the communication interface. The communication interface is configured to receive payment card information provided by a user to an online merchant in relation to online purchase transaction. The payment card information is associated with consent from the user to add a corresponding payment card to a digital wallet account. The processor is configured to perform one of: (1) create the digital wallet account for the user if no record of the digital wallet account for the user exists at the server system and add the payment card to the digital wallet account created for the user, and (2) add the payment card to the digital wallet account if a record of the digital wallet account for the user exists at the server system. The payment card is added to the digital wallet account using the payment card information. The processor is configured to facilitate processing of payment for the online purchase transaction based on the payment card information associated with the payment card.

In one embodiment, a method for facilitating digital wallet based payment card transactions is disclosed. The method receives, by a processor, personal contact information related to a user from an online merchant. The user is engaged in an online purchase transaction with the online merchant. The method determines, by the processor, if a record of the digital wallet account for the user exists in a database using the personal contact information. The method receives, by the processor, payment card information provided by the user to the online merchant in relation to the online purchase transaction. The payment card information is associated with consent from the user to add a corresponding payment card to the digital wallet account. The method creates the digital wallet account for the user by the processor if no record of the digital wallet account for the user exists in the database. The method facilitates, by the processor, user activation of the digital wallet account using the personal contact information. Subsequent to activation of the digital wallet account, the method adds the payment card to the digital wallet account by the processor upon successful user authentication. The payment card is added to the digital wallet account using the payment card information. The processing of payment for the online purchase transaction is performed based on the payment card information associated with the payment card.

### BRIEF DESCRIPTION OF THE FIGURES

For a more complete understanding of example embodiments of the present technology, reference is now made to the following descriptions taken in connection with the accompanying drawings in which:

FIG. 1 is a schematic diagram illustrating an exemplary multi-party payment card system for enabling payment-by-card transactions in which merchants and card issuers do not necessarily have a one-to-one relationship;

FIG. 2 is a simplified block diagram illustrating communication between a server system of a payment network and a plurality of electronic devices, in accordance with one embodiment of the present invention;

FIG. 3 is a simplified block diagram of the server system of FIG. 2, in accordance with one embodiment of the present invention;

FIG. 4 illustrates an example configuration of an electronic device, in accordance with one embodiment of the present invention;

FIG. 5A shows a representation of a UI displaying a digital wallet based payment option to a user during a checkout stage of an online purchase transaction, in accordance with one embodiment of the present invention;

FIG. 5B shows a representation of a UI displayed to a user by a merchant application for receiving payment card information, in accordance with one embodiment of the present invention;

FIG. 6 shows a representation of a UI displaying a message including a password-reset link for facilitating activation of a digital wallet account, in accordance with one embodiment of the present invention;

FIG. 7 shows a representation of a UI displaying a form field capable of receiving user input corresponding to an One Time Password (OTP), in accordance with one embodiment of the present invention;

FIG. 8 shows a UI including digital wallet based payment option displaying a payment card number in a masked format, in accordance with one embodiment of the present invention;

FIG. 9 shows a sequence flow diagram for illustrating an example sequence of steps for facilitating digital wallet based payment transactions, in accordance with one embodiment of the present invention;

FIG. 10 is a flow diagram of an example method for facilitating digital wallet based payment transactions, in accordance with one embodiment of the present invention; and

FIG. 11 is a flow diagram of an example method for facilitating digital wallet based payment transactions, in accordance with another embodiment of the present invention.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

It is noted that the term ‘online merchant’ as used hereinafter refers to a digital presence of a physical merchant and as such, the term ‘online merchant’ and ‘merchant application’ are used interchangeably throughout the specification for the purposes of description. Further, the term ‘digital wallet’ as used hereinafter refers to a collection of all payment card and shipping information related to a user stored in an online repository, whereas the term ‘digital wallet account’ refers to a personal account based access means for accessing the digital wallet stored in the online repository. It is noted that the terms ‘digital wallet’ and ‘digital wallet account’ are also used interchangeably when referring to accessing content stored in the digital wallets.

### Overview

Digital Wallets enable users to make online purchase transactions in a simple, convenient and secure manner. A digital wallet stores a user's banking card and shipping information in one secure location. The stored information may be used by the user to shop online and check out faster. In spite of several benefits afforded by the use of digital wallets, the digital wallet service has seen limited adoption because of the drawbacks of the current implementations. For example, currently, the users have to access a UI associated with the digital wallet service provider to sign-up and create an account with the digital wallet service provider, which may put off users from using the digital wallet service. Furthermore, in some example scenarios, if a user does not want to use a payment card included within a digital wallet for an ongoing online purchase transaction, then the user has to login to the digital wallet account and add a new payment card to the account to use the new payment card for the ongoing online purchase transaction. This may be cumbersome for the user and the user may abandon the online purchase transaction altogether.

Various embodiments of the present invention provide methods and system for overcoming the above drawbacks and providing additional advantages. More specifically, various embodiments as disclosed herein facilitate digital wallet based payment transactions while precluding cumbersome effort on part of the users. In one embodiment, a server system associated with a payment network is provided. The server system includes a database including records of digital wallet accounts for a plurality of users. In an example scenario, a user may wish to engage in an online purchase transaction with an online merchant using a digital wallet account and, accordingly, may select a digital wallet based payment option displayed on the merchant's Website during the checkout process. The online merchant may be configured to check with the server system if a record of a digital wallet account exists for the user in the database. In at least one example embodiment, the user's personal contact information, such as the user's Email address and/or the phone number, may be used by the server system to check if the record of the digital wallet account exists for the user or not.

If no record of the digital wallet account exists for the user in the database, the server system is configured to cause the online merchant to request payment card information from the user. The user may provide the payment card information (i.e. payment card number, payment card expiry, CVC2, etc.) along with consent to add the corresponding payment card (i.e. the payment card bearing the payment card information) to a digital wallet account. The server system is configured to receive the payment card information along with user consent. The server system is further configured to create a digital wallet account for the user by using the personal contact information. Subsequent to the creation of the digital wallet account, a password-reset link is sent to the customer by the server system to reset the password of the created digital wallet account and activate the digital wallet account. The user may thereafter be authenticated using 3-D Secure (hereinafter referred to as 3DS) or any such authentication mechanism subsequent to the successful activation of the digital wallet account. Subsequent to successful authentication, the server system is configured to add the payment card to the created digital wallet account and share the payment card information with the online merchant to facilitate processing of the online purchase transaction. The online merchant may provision the full primary account number (PAN) of the payment card to its banking institution (i.e. to the merchant bank, also referred to herein as the acquirer), which may then communicate with the banking institution of the card provider associated with the selected payment card (i.e. with the issuer of the payment card) to authorize and process the purchase transaction. Thus, by providing the payment card information and consent to add the payment card information to a digital wallet account during an online checkout process, a user may create a digital wallet account during the ongoing online purchase transaction itself. Such creation of the digital wallet account and addition of a banking card to the digital wallet account precludes the cumbersome effort on part of the user to intentionally sign-up for an account on the Website or the online portal of the digital wallet service provider.

As explained above, the user may select the digital wallet based payment option displayed on the merchant's Website during the checkout process and the online merchant may be configured to check with the server system if a record of a digital wallet account exists for the user in the database. In case, a record of the digital wallet account exists for the user in the database, the server system is configured to retrieve one or more payment cards included within the digital wallet account of the user and cause display of a list of payment card numbers in a masked format to the user on the merchant Website. In some embodiments, the user may choose to use a different payment card, which is not included within the digital wallet. In such a scenario, the server system is configured to cause the online merchant to request payment card information of the different payment card from the user. The user may provide the payment card information (i.e. payment card number, payment card expiry, CVC2, etc.) along with consent to add the corresponding payment card to a digital wallet account. The server system is configured to receive the payment card information along with user consent and thereafter initiate user authentication using 3DS or any such authentication mechanism. Subsequent to successful authentication, the server system may add the payment card to the digital wallet account and facilitate processing of the online purchase transaction using the newly added payment card as explained above.

It is noted that in some scenarios, the user may choose a payment card from among the displayed payment card numbers in masked format for executing the online purchase transaction. In such a scenario, the server system may be configured to authenticate the user using any 3DS mechanism (such as one time password or OTP, for example) and upon successful authentication, provision the full primary account number (PAN) to the online merchant to facilitate processing of the online purchase transaction.

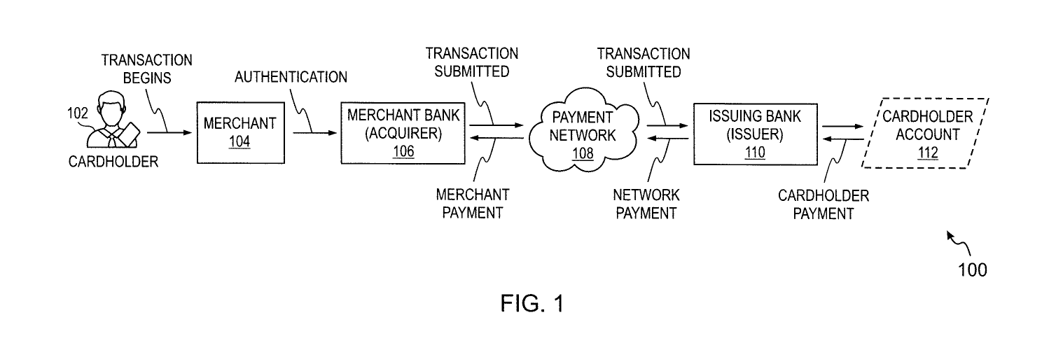

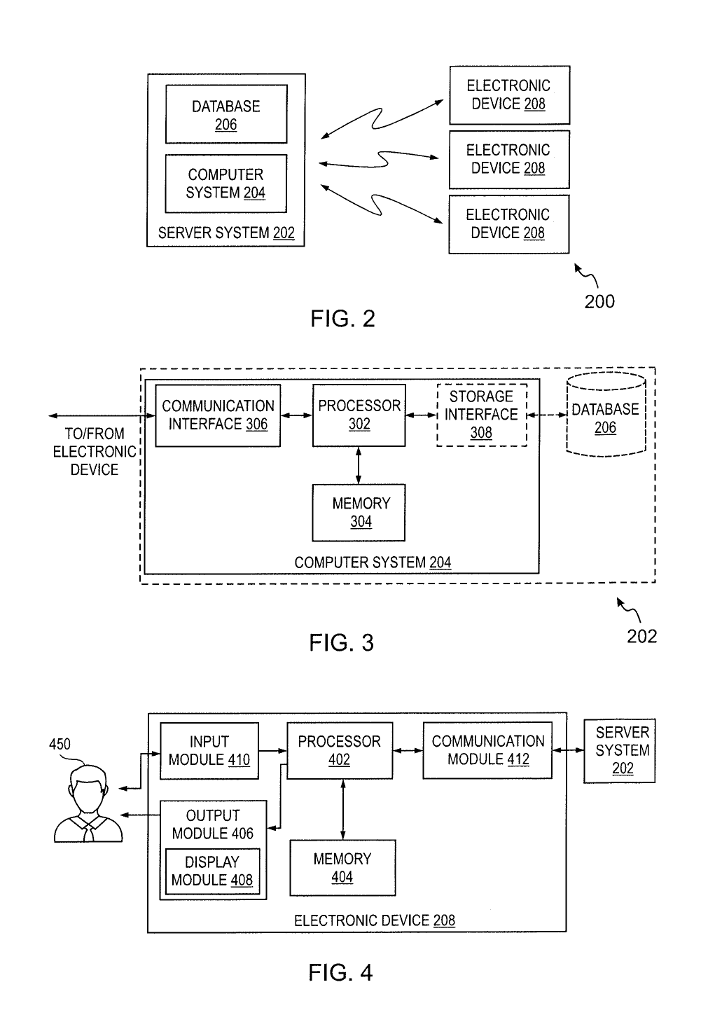

FIG. 1 shows a representation for illustrating a typical payment card based transaction. Various example embodiments of present invention are described with reference to FIGS. 2 to 11.

Referring now to FIG. 1, a schematic diagram illustrating an exemplary multi-party payment card system 100 for enabling payment-by-card transactions in which merchants and card issuers do not necessarily have a one-to-one relationship. The present invention relates to payment card system 100, such as a credit card payment system using a payment card system interchange network 108 such as the Mastercard® payment card system interchange network. Mastercard® payment card system interchange network is a proprietary communications standard promulgated by Mastercard International Incorporated® for the exchange of financial transaction data between financial institutions that are members of Mastercard International Incorporated®. (Mastercard is a registered trademark of Mastercard International Incorporated located in Purchase, N.Y.). The payment card system interchange network 108 is hereinafter referred to as payment network 108.

In payment card system 100, a financial institution such as an issuer 110 issues a payment account card, such as a credit card account or a debit card account, to a cardholder 102, who uses the payment account card to tender payment for a purchase from a merchant 104. In at least one embodiment, the merchant 104 is an online seller offering one or more products or services on a digital platform, such as an electronic commerce (E-commerce) platform. To accept payment with the payment account card, the merchant 104 must normally establish an account with a financial institution that is part of the financial payment system. This financial institution is usually called the “merchant bank” or the “acquiring bank” or “acquirer bank” or simply “acquirer”. When a cardholder 102 tenders payment for a purchase with a payment account card (also known as a financial transaction card), merchant 104 requests authorization from acquirer 106 for the amount of the purchase. The request may be performed over the telephone, or through the use of a point-of-sale (POS) terminal, which reads the cardholder's account information from the magnetic stripe on the payment account card and communicates electronically with the transaction processing computers of acquirer 106, or through payment gateways as in the case of online payment transactions. Alternatively, acquirer 106 may authorize a third party to perform transaction processing on its behalf. In this case, the point-of-sale terminal or the payment gateway will be configured to communicate with the third party. Such a third party is usually called a “merchant processor” or an “acquiring processor.”

Using payment network 108, the computers of acquirer 106 or the merchant processor will communicate with the computers of issuer 110 to determine whether the cardholder's account is in good standing and whether the purchase is covered by the cardholder's available credit line or account balance. Based on these determinations, the request for authorization will be declined or accepted. If the request is accepted, an authorization code is issued to merchant 104.

When a request for authorization is accepted, the available credit line or available balance of cardholder's account 112 is decreased. Normally, a charge is not posted immediately to a cardholder's account because bankcard associations, such as Mastercard International Incorporated®, have promulgated rules that do not allow a merchant to charge, or “capture,” a transaction until goods are shipped or services are delivered. When a merchant ships or delivers the goods or services, merchant 104 captures the transaction by using, for example, appropriate data entry procedures. If a cardholder cancels a transaction before it is captured, a “void” is generated. If a cardholder returns goods after the transaction has been captured, a “credit” is generated.

For debit card transactions, when a request for a personal identification number (PIN) authorization is approved by the issuer 110, the cardholder's account 112 is decreased. Normally, a charge is posted immediately to cardholder's account 112. The bankcard association then transmits the approval to the acquiring processor for distribution of goods/services, or information or cash in the case of an ATM.

After a transaction is captured, the transaction is settled between merchant 104, acquirer 106, and issuer 110. Settlement refers to the transfer of financial data or funds between the merchant's account, acquirer 106, and issuer 110 related to the transaction. Usually, transactions are captured and accumulated into a “batch,” which is settled as a group.

Financial transaction cards or payment account cards refer to cards used as a method for payment for performing transactions. As described herein, the term “financial transaction card” or “payment account card” includes cards such as credit cards, debit cards, and prepaid cards, but also includes any other devices that may hold payment account information, such as mobile phones, personal digital assistants (PDAs), and key fobs. Financial transaction cards or payment account cards are hereinafter referred to as “payment cards”. The transactions performed using the payment cards are referred to as “payment card transactions” or “financial transactions”. An example of a financial transaction may include online payment for purchase of a product or a service.

FIG. 2 is a simplified block diagram 200 illustrating communication between a server system 202 of a payment network and a plurality of electronic devices, in accordance with one embodiment of the present invention. In one embodiment, the payment network may correspond to a payment card system interchange network such as the Mastercard® payment card system interchange network 108 explained with reference to FIG. 1. In one embodiment, the payment network may correspond to a transaction-processing network of an issuing bank (or the issuer 110 shown in FIG. 1). In one embodiment, the payment network may correspond to payment processing network of an online merchant, such as an E-commerce company, for example. The server system 202 of the payment network is configured to facilitate payment card transactions as explained with reference to FIG. 1, while using digital wallets.

The server system 202 of the payment network includes a computer system 204 and a database 206. As shown in FIG. 2, several electronic devices 208 are in operative communication with the server system 202. The electronic devices 208 may be interconnected to the Internet through many interfaces including a network, such as a local area network (LAN) or a wide area network (WAN), dial-in-connections, cable modems, and special high-speed ISDN lines.

In one embodiment, one of electronic devices 208 may correspond to a personal computing device of a user (also referred to herein as an online customer) associated with one or more payment cards. Some non-exhaustive examples of the personal computing device may include a smartphone, a laptop, a desktop, a workstation terminal, a wearable device, a tablet computer, a personal digital assistant (PDA), and the like.

In one embodiment, one of electronic devices 208 may be associated with an acquirer while another one of electronic devices 208 may be associated with an issuer.

In one embodiment, one of electronic devices 208 may be associated with an online merchant.

The server system 202 is explained in further detail with reference to FIG. 3.

FIG. 3 is a simplified block diagram of the server system 202 of FIG. 2, in accordance with one embodiment of the present invention. As explained above, the server system 202 is a part of the payment network. The server system 202 includes the computer system 204 and the database 206.

The computer system 204 includes a processor 302 for executing instructions. Instructions may be stored in, for example, but not limited to, a memory 304. Processor 302 may include one or more processing units (e.g., in a multi-core configuration).

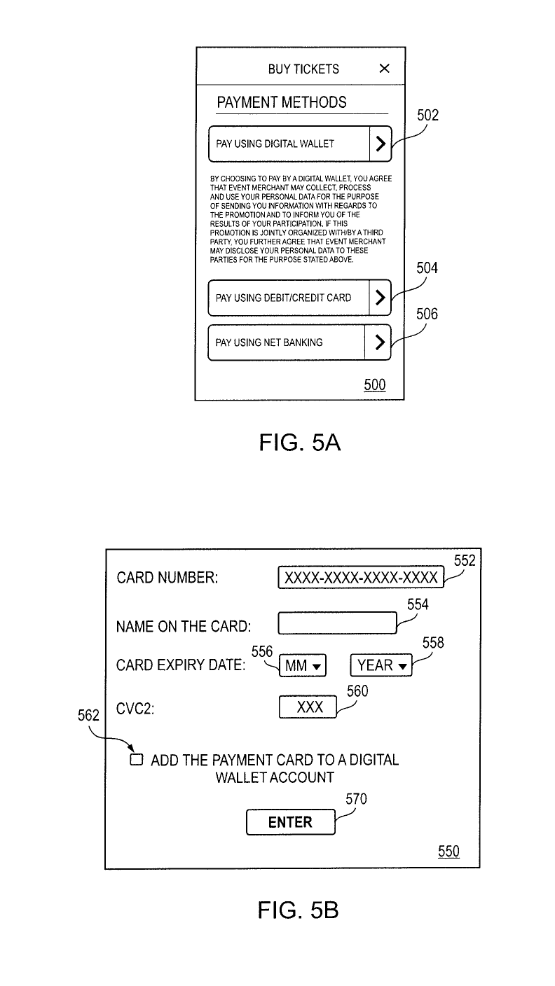

The processor 302 is operatively coupled to a communication interface 306 such that computer system 204 is capable of communicating with a remote device such as an electronic device 208 (shown in FIG. 2). For example, the communication interface 306 may receive requests from an electronic device 208 associated with an online customer, an online merchant, and the like, via the Internet, for facilitating digital wallet based payment card transactions, as will be explained later with reference to FIGS. 5A to 8.

The processor 302 may also be operatively coupled to the database 206. The database 206 is any computer-operated hardware suitable for storing and/or retrieving data, such as, but not limited to, digital wallet accounts of a plurality of users. Each digital wallet account may be associated with an account number and other account identifiers. Further, each digital wallet account includes data related to one or more user payment cards, user shipping information and personal contact information of the user. The data related to each payment card may include information such as a cardholder name, a card number, card expiry details, card security code (for example, CVC2), and the like. It is noted that each payment card from among the one or more user payment cards is capable of facilitating at least one financial transaction. The database 206 may also store transaction data generated as part of sales activities conducted over the bankcard network including data relating to merchants, account holders or customers, and purchases. The stored merchant data may include a merchant identifier that identifies each merchant registered to use the payment network, and instructions for settling transactions including merchant bank account information. The database 206 may include multiple storage units such as hard disks and/or solid-state disks in a redundant array of inexpensive disks (RAID) configuration. The database 206 may include a storage area network (SAN) and/or a network attached storage (NAS) system.

In some embodiments, the database 206 is integrated within computer system 204. For example, computer system 204 may include one or more hard disk drives as database 206. In other embodiments, database 206 is external to computer system 204 and may be accessed by the computer system 204 using a storage interface 308. The storage interface 308 is any component capable of providing processor 302 with access to the database 206. The storage interface 308 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 302 with access to the database 206.

FIG. 4 illustrates an exemplary configuration of an electronic device 208, in accordance with one embodiment of the invention. The electronic device 208 may correspond to a personal computing device of an online customer (i.e. a user), a computing device associated with an acquirer or an issuer, a computing device associated with an online merchant, and the like.

The electronic device 208 includes a processor 402 for executing instructions. In some embodiments, executable instructions are stored in a memory 404. The processor 402 may include one or more processing units (e.g., in a multi-core configuration). The memory 404 is any device allowing information such as executable instructions and/or transaction data to be stored and retrieved. The memory 404 may include one or more computer readable media.

The electronic device 208 also includes an output module 406 for presenting information to a user 450 (such as an online customer, online merchant, and the like). The output module 406 is any component capable of conveying information to the user 450. In some embodiments, output module 406 includes an output adapter (not shown) such as a video adapter and/or an audio adapter. An output adapter is operatively coupled with the processor 402 and with an output device such as a display module 408 (e.g., a cathode ray tube (CRT), liquid crystal display (LCD), light emitting diode (LED) display, or “electronic ink” display) or an audio output device (e.g., a speaker or headphones). In some embodiments, display module 408 is configured to present a graphical user interface (e.g., a web browser and/or a client application) to the user 450. A graphical user interface may correspond to, for example, an online store interface for viewing and/or purchasing items, a digital wallet application for managing payment information, and the like.

In some embodiments, electronic device 208 includes an input module 410 for receiving input from the user 450. The user 450 may use input module 410 to select one or more items to purchase, to select a digital wallet payment option, to input payment card information, and the like. The input module 410 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both the display module 408 of the output module 406 and the input module 410.

The electronic device 208 also includes a communication module 412, which is configured to communicate with a remote device such as the server system 202 (explained with reference to FIG. 3). The electronic device 208, using the communication module 412, may be interconnected to the Internet through many interfaces including a network, such as a local area network (LAN) or a wide area network (WAN), dial-in-connections, cable modems, and special high-speed ISDN lines. The communication module 412 may include, for example, a wired or wireless network adapter and/or a wireless data transceiver for use with a mobile telecommunications network.

Stored in memory 404 are, for example, computer readable instructions for providing a user interface (UI) to the user 450 via the display module 408 and, optionally, receiving and processing input from the input module 410. The UI may include, among other possibilities, a Web browser and/or a client application. Web browsers enable users, such as the user 450, to display and interact with media and other information typically embedded on a Web page or a Website from the server system 202. A client application allows the user 450 to interact with a server application of a merchant computer system, and/or the server system 202.

As explained above, in some embodiments, the user 450 may correspond to an online customer and the electronic device 208 may correspond to a personal computing device of the online customer. The user 450 may use the electronic device 208 to access a merchant application (such as a Website or a mobile application associated with an online merchant) offering products or services for sale. The user 450 may view several items of interest displayed on the merchant application and choose an item for purchase. In an illustrative example, the online merchant may correspond to Web ticketing solution provider. A Website associated with the online merchant may provide options to an online visitor to book tickets for upcoming events, such as musical concerts, theatrical performances, and the like. In an example scenario, a user (i.e. an online visitor to the Website) may be interested in purchasing tickets for a musical concert and accordingly, may signup for an account with the online merchant using the Website. In at least some embodiments, the user may provide personal contact information, such as an electronic mail (Email) address, a phone number and address details (such as shipping address, for example) during the signup process. The Website associated with the online merchant may send a verification link to the email address and/or the phone number to verify the account details of the user. Subsequent to successful verification, the signup process may be completed and the user may be registered account holder with the online merchant. The user may thereafter view available seat options for various shows of the event of interest displayed on the Web pages associated with the Website.

In at least some embodiments, subsequent to making appropriate selections of show timings and seat options, the user may proceed to checkout, i.e. make a payment for the online purchase of tickets. Accordingly, the Website associated with the online merchant may be configured to display various payment options to the user to initiate a payment transaction. In at least one example embodiment, the Website may display an option to make a payment using a digital wallet to the user. An example UI displaying a digital wallet based payment option to a user for facilitating online purchase of an item (i.e. event tickets in this case) is shown in FIG. 5A.

FIG. 5A shows a representation of a UI 500 displaying a digital wallet based payment option to a user during a checkout stage of an online purchase transaction, in accordance with one embodiment of the present invention. In the illustrative example explained above, the online purchase transaction corresponds to a transaction related to purchase of tickets for an event and the online merchant corresponds to a Web ticketing solution provider offering options to book tickets for upcoming events, such as musical concerts, theatrical performances, and the like.

In one embodiment, the UI 500 may correspond to a Web page associated with a Website of an online merchant. It is understood that the Website of the online merchant may include several Web pages displaying several events with corresponding show timings and available seating options to the prospective buyers of the tickets. Further, it is understood that several users may visit the Website of the online merchant for viewing events for which tickets are offered for sale and at least some users may purchase one or more tickets for events of interest. Each user may access the Website of the online merchant by entering a Uniform Resource Locator (URL) in a Web browser application installed in his or her respective electronic device.

In one embodiment, the UI 500 may correspond to UI of a mobile application associated with the online merchant. The user may download the mobile application from a Web application store onto a personal electronic device, such as a smartphone or a tablet device, and thereafter access the mobile application to view booking options for event tickets. The Website or the mobile application offering an UI, such as the UI 500, to the user is hereinafter referred to as merchant application for purposes of description.

As explained above, the UI 500 is displayed to the user during the checkout stage, i.e. when a user decides to make payment for the items selected for purchase. The UI 500 is depicted to display several options to the user to make the payment. More specifically, the UI 500 is depicted to display an option 502 to make a payment using a digital wallet; an option 504 to make an input using a debit card or a credit card; and an option 506 to make payment using net banking. The user may provide a click or touch input on an option from among the displayed options 502-506 to provide selection of a payment option.

In at least one example embodiment, the merchant application may be configured to cause determination of whether the user is associated with a digital wallet account or not. To that effect, the merchant application may share user's account related information with a server system, such as the server system 202 (shown in FIG. 2). As explained with reference to FIG. 3, the server system 202 includes a database 206 configured to store information related to digital wallet accounts for a plurality of users. In one embodiment, the merchant application may share personal contact information, such as Email address and phone number with the server system 202. The server system 202 may be configured to receive the personal contact information provisioned by the merchant application. In some embodiments, Application Programming Interfaces (APIs) may be defined for merchant applications by the server system 202 for facilitating bi-directional transfer of information over a communication network, such as the Internet. It is noted that the communication interface 306 of the server system 202 may be configured to receive the personal contact information provided by the merchant application and relay the information to the processor 302. The processor 302 is configured to lookup the email address and/or the phone number in the database 206 to determine if a record of a user digital wallet account exists among the plurality of digital wallet accounts. It is noted that the digital wallet account of the user may include information related to one or more payment cards and shipping information, in addition to personal information, such as name, Email address and phone number of the user. Accordingly, the processor 302 may be configured to compare the personal contact information with information present in the database 206 and determine if the record of the digital wallet account for the user exists in the database 206 or not. The processor 302 may further be configured to communicate the result of the said determination to the merchant application through the communication interface 306.

In at least some example scenarios, a record of a digital wallet account for the user may exist in the database 206. In such a scenario, the processor 302 may be configured to provide a list of one or more payment card numbers in masked format to the merchant application. In one embodiment, the merchant application may be caused to display the option 502, i.e. digital wallet based payment option, including at least one payment card number in a masked format to the user if the record of the digital wallet account for the user exists in the database 206. For example only the last four digits of the payment card number may be displayed to the user in the option 502. In an illustrative example, the option 502 may display text ‘XXXX-1234’ to enable selection of a payment card ending in digits 1234 included within the digital wallet account to make a payment. However, in some embodiments, no record of the digital wallet account may exist for the user in the database 206 and the processor 302 may be configured to communicate to the merchant application that no record of digital wallet account for the user exists in the database 206. In such a scenario, the merchant application may be caused to display the digital wallet based payment option as shown using option 502 in FIG. 5A. More specifically, the option 502 may preclude display of any payment card number in the masked format. In an embodiment, the user may select the digital wallet based payment option by providing a click or a touch input on the option 502. In at least one example embodiment, a UI displaying form fields for receiving payment card information from the user may be displayed to the user. Such a UI is shown in FIG. 5B.

FIG. 5B shows a representation of a UI 550 displayed to a user by the merchant application for receiving payment card information, in accordance with one embodiment of the present invention. As explained with reference to FIG. 5A, a user may choose an item of interest, such as for example tickets for a musical concert, and subsequently initiate an online purchase transaction by selecting a digital wallet payment option, such as the option 502 (shown in FIG. 5A). In case, a record of the digital wallet account for the user does not exist in the database 206, or, in case a record of the digital wallet account for the user exists in the database 206 but the user chooses to use a different payment card than the payment cards included within the digital wallet account, then the merchant application may be caused to provision a UI, such as the UI 550, for facilitating provisioning of the payment card information by the user. The UI 550 may correspond to a Web page UI or a mobile application UI as explained with reference to FIG. 5A.

In one embodiment, the UI 550 is depicted to display a plurality of form fields, such as form fields 552, 554, 556, 558 and 560 for facilitating provisioning of the payment card information by the user. Each form field from among the form fields 552-560 is capable of receiving a user input, such as a text input or a selection input. For example, the form field 552 is depicted to be associated with text ‘Card Number’. The user may provide a 16-digit numerical input corresponding to the number of the payment card in the form field 552. In one embodiment, the form field 552 may be capable of receiving input in form of ‘XXXX-XXXX-XXXX-XXXX’, where ‘X’ corresponds to a positive integer. In one embodiment, the user may sequentially input the digits of the payment card number and the form field 552 may be configured to align the numbers in the form, depicted above. In some embodiments, the UI 550 may also include another form field, such as the form field 552, requesting the user to reconfirm the payment card number and the merchant application may be configured to display an error flag if the payment card number entered in the two form fields do not match.

The form field 554 is depicted to be associated with text ‘Name on the Card’ and the user may provide a string of alphabets corresponding to the name of the individual displayed on the payment card in the form field 554. The form fields 556 and 558 are depicted to be associated with text ‘Card Expiry Date’, and the user may provide a selection input corresponding to the month and year of the expiry of the payment card displayed on the payment card in the form fields 556 and 558, respectively.

The form field 560 is depicted to be associated with text ‘CVC2’. Accordingly, the user may input a 3-digit numerical input corresponding to the security code of the payment card in the form field 560. In one embodiment, the form field 560 may be capable of receiving user input in form of ‘XXX’, where ‘X’ corresponds to a positive integer.

It is noted that the information provided in the form fields 552-560 by the user configures the ‘payment card information’ for the purposes of the description. More specifically, the user input in the form fields for payment card number, name on the card, payment card expiry details and CVC2 configure the payment card information.

The UI 550 also includes a consent box 562 exemplarily depicted to be associated with text ‘Add the payment card to a digital wallet account’. The user may provide a selection input corresponding to the consent box 562 subsequent to entering information in the form fields 552-560. The user input corresponding to the consent box 562 is indicative of user's consent to adding the payment card (i.e. a banking card for which the payment card information was entered in the form fields 552-560) to a digital wallet account.

Thereafter, the user may select the button 570 exemplarily depicted to display text ‘Enter’ to provide confirmation of the information included in the form fields 552-562. Upon user selection of the button 570, the merchant application may be configured to provision the payment card information along with indication that the user has consented to add the payment card to a digital wallet account to the server system 202. In at least one example embodiment, the merchant application may also be configured to provision the personal contact information along with payment card information to the server system 202. The provisioning of such information may be performed over a communication network as explained with reference to FIGS. 2 and 3. The communication interface 306 associated with the server system 202 may be configured to receive the payment card information along with the user consent provisioned by the online merchant, or more specifically, by the merchant application associated with the online merchant.

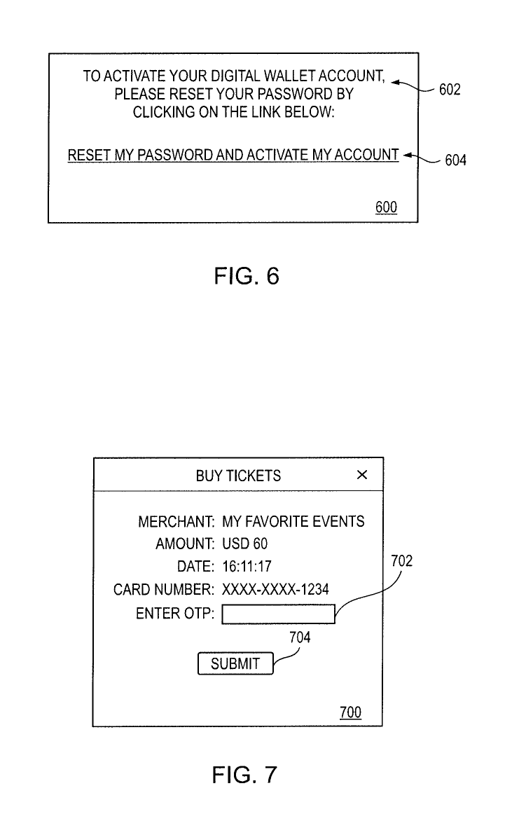

In at least one example embodiment, the processor 302 of the server system 202 is configured to create a digital wallet account for the user if no record of the digital wallet account for the user exists in the database 206. The processor 302 may use the user's personal contact information, such as for example the user's email address, phone number and shipping address to create the digital wallet account for the user. The term ‘creation of a digital wallet account’ as used herein implies creating a record in the database 206. Each record is associated with login information, such as a username and a password. The record may include data fields storing user information, such as user's email address, phone number and shipping address. Furthermore, each record may be configured to store information related to at least one payment card (such as the payment card information entered in the form fields 552 to 560). In an illustrative example, the processor 302 may be configured to use the user's email address as the username and generate a temporary login password for creating the digital wallet account. The processor 302 may also be configured to provision a password-reset link to the user by using the personal contact information of the user to enable the user to reset the password and facilitate activation of the created digital wallet account. In one embodiment, the password-reset link may be included in an Email and forwarded to the Email address of the user. In one embodiment, the password-reset link may be included in a message, such as short message service (SMS) or an instant message (IM) and forwarded to the user's phone number. An illustrative message provisioned by the server system 202, or more specifically, by the processor 302 to the user for facilitating activation of the digital wallet account is depicted in FIG. 6.

FIG. 6 shows a representation of a UI 600 displaying a message including a password-reset link for activation of a digital wallet account, in accordance with one embodiment of the present invention. As explained with reference to FIG. 5B, subsequent to receiving payment card information and user consent from the online merchant, the server system 202, or more specifically, the processor 302 of the server system 202 may be configured to create a digital wallet account for the user if no record of the digital wallet account for the user exists in the database 206. Subsequent to creation of the digital wallet account, the processor 302 may be configured to provision a message including a password-reset link to the user to facilitate activation of the created digital wallet account. As explained with reference to FIG. 5B, the message may be embodied as an Email message, a SMS message or an instant message. Accordingly, the UI 600 may be displayed on a display screen of the user's electronic device.

The UI 600 is exemplarily depicted to display text 602: ‘To activate your digital wallet account, please reset your password by clicking on the link below’. The text 602 may be associated with a hyperlink 604 exemplarily depicted to include text ‘Reset my password and activate my account’. Upon user selection of the hyperlink 604 either by using a touch input or a click input, another UI (not shown in FIG. 6) may be displayed to the user, wherein the user may have to select a password for the digital wallet account. Upon user selection of the password, the digital wallet account may be deemed to be active. More specifically, the digital wallet account may now be capable of storing one or more payment card information and shipping information of the user, and moreover, the stored information can now be used for facilitating payment card transactions, such as for online shopping.

In at least one example embodiment, the server system 202 may be configured to add the payment card information, i.e. the information entered by the user in the form fields 552 to 560, to the activated digital wallet account. In at least some embodiments, the processor 302 may be configured to cause authentication of the user subsequent to the activation of the created digital wallet account to facilitate addition of the payment card to the digital wallet account. To authenticate the user, 3DS or any known authentication mechanism, may be utilized. For example, the processor 302 may cause the merchant application (i.e. the merchant Website or the merchant mobile application) to display a UI requesting the user to input One Time Password (OTP). The processor 302 may be configured to provision the OTP to the user's phone number and/or email address. An illustrative UI requesting the user to enter the OTP is shown in FIG. 7.

FIG. 7 shows a representation of a UI 700 displaying a form field 702 capable of receiving user input corresponding to an OTP, in accordance with one embodiment of the present invention. As explained with reference to FIG. 6, subsequent to activation of the digital wallet account, the server system 202 may be configured to cause display of an UI on the merchant's application requesting the user to enter the OTP to authenticate the user. The OTP may be provisioned to the user on the user's phone number and/or Email address recorded in the digital wallet account. The user may enter the OTP in the form field 702 and select the button 704 showing text ‘Submit’ to provision the OTP to the processor 302, which may be configured to compare the user input with the OTP generated by the processor 302 to authenticate the user. Subsequent to the successful authentication, the processor 302 may be configured to facilitate processing of payment for the online purchase transaction based on the payment card information associated with the payment card. As explained with reference to FIG. 1, using payment network (i.e., using the server system 202 associated with the payment network), the computers of the merchant's banking institution (i.e. the acquirer 106 shown in FIG. 1) may communicate with the computers of the banking institution which issued the payment card to the user (i.e. the issuer 110 shown in FIG. 1) to determine whether the user's account is in good standing and whether the purchase is covered by the user's available credit line or account balance. Based on these determinations, the authorization for online purchase transaction is declined or accepted. If the payment card information is verified, the online purchase transaction is authorized. Subsequent to the successful authorization of the online purchase transaction, the billed amount of money may be transferred from the user's banking account to an account associated with the online merchant. Accordingly, the available credit line or available balance of user's account is decreased.

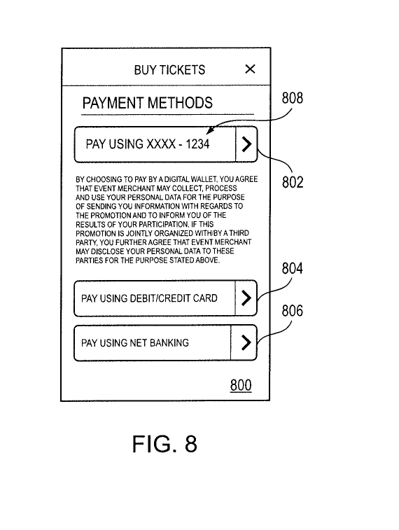

In some example scenarios, the user may access the merchant application at a later point in time for another purchase transaction, such as for example to buy tickets for another event. Accordingly, as explained with reference to FIG. 5A, the user may be displayed several options to make the payment by the merchant application, once the user initiates the checkout process. Prior to displaying the several options, the merchant application is configured to initiate determination of whether a digital wallet account for the user exists for not. Since the user has already created the digital wallet account during the previous payment card transaction and added the payment card to the digital wallet account, then in such a scenario, a record of the digital wallet account exists for the user in the server system 202 (or more specifically, in the database 206 of the server system 202). In at least one example embodiment, if a record of the digital wallet account exists for the user, then the processor 302 of the server system 202 may be configured to cause display of the payment card number of the payment card included within the digital wallet account to the user in a masked format. The display of the payment card number in a masked format is shown in FIG. 8.

Referring now to FIG. 8, a UI 800 including digital wallet based payment option 802 displaying a payment card number 808 in a masked format, in accordance with one embodiment of the present invention. As explained with reference to FIG. 5A, prior to displaying all the payment options to the user during the checkout stage of the payment card transaction, a check is performed to determine if a record of a digital wallet account exists for the user in the database 206 of the server system 202. If no record of the digital wallet account exists, then the user may be requested to provide the payment card information and, further, the user may choose to provide consent for adding the corresponding payment card to a digital wallet account. The server system 202 may then be caused to create the digital wallet account and add the payment card to the digital wallet account as explained with reference to FIGS. 5A to 7. However, if the server system 202 determines that a record of the digital wallet account exists for the user based on the personal contact information of the user shared by the merchant application, then in such a scenario, the server system 202 or more specifically, the processor 302 of the server system 202 may be configured to retrieve the payment card included with the digital wallet account and cause display of the payment card number in a masked format as shown in FIG. 8. More specifically, the UI 800 displays several payment options, such as the digital wallet based payment option 802, the debit/credit card based payment option 804 and the net banking based payment option 806. The debit/credit card based payment option and the net banking based payment option are similar to options 504 and 506 explained with reference to FIG. 5A. The digital wallet based payment option 802 is depicted to display a payment card number 808 as ‘XXXX-1234’. More specifically, only the last four digits of the user's payment card are shown to the user. If the user chooses to make a payment for the online purchase transaction using the payment card ending with digits 1234, then the user may select the option 802 and thereafter the online merchant may share the full primary account number (PAN) with the merchant application, which may then be configured to initiate authorization and processing of the online purchase transaction as explained with reference to FIG. 7.

However, in some example embodiments, the user may choose to use a different payment card then the payment card ending with digits 1234. In such a case, the user may choose to enter the payment card information of the new payment card and select a consent box, such as the consent box 562 (shown in FIG. 5B), to add the new payment card to the digital wallet account as explained with reference to FIG. 5B. In such a scenario, the server system 202 may be configured to perform user authentication using 3DS (for example, OTP based authentication) as explained with reference to FIG. 6 to add the new payment card to the digital wallet account and thereafter facilitate processing of the payment card transaction using the added payment card as explained with reference to FIG. 7.

As can be seen, the user is spared the effort of dedicatedly signing up or logging in to the digital wallet account while creating or adding a new payment card to the digital wallet account. Moreover, the user is also spared the effort of adding the payment card and shipping information in various form fields, thereby making it very convenient for the users to use digital wallet accounts for online purchase transactions.

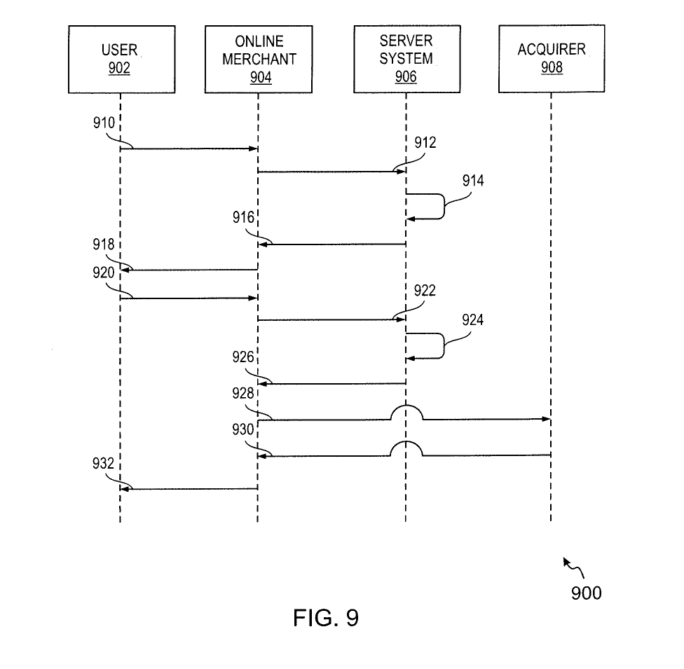

FIG. 9 represents a sequence flow diagram 900 for illustrating an example sequence of steps for facilitating digital wallet based payment transactions, in accordance with one embodiment of the present invention. The sequence flow diagram 900 depicts a plurality of blocks, such as blocks 902, 904, 906 and 908. The blocks 902, 904, 906 and 908 represent a user (i.e. an online customer), an online merchant, a server system associated with a payment network and an acquirer, respectively. The server system 906 may be similar to the server system 202 explained with reference to FIGS. 2 to 8.

The sequence flow diagram 900 starts at 910. At 910, the user 902 accesses a merchant application, such as mobile application or a Website, associated with the online merchant 904 using an electronic device (such as the electronic device 208 explained with reference to FIG. 4) and initiates a checkout process for an item selected to be purchased on the merchant application. It is noted that the term ‘online merchant 904’ used hereinafter, implies the merchant application associated with the online merchant 904. In at least some embodiments, the user 902 may have created an account with the online merchant 904 and provided personal contact information, such as Email address, phone number, shipping address, etc. to the online merchant 904 prior to initiating the checkout process.

At 912, the online merchant 904 provides the personal contact information, such as phone number and/or Email address to the server system 906 to determine if a digital wallet account exists for the user 902 at the server system 906. At 914, the server system 906 performs a lookup operation in a database (such as the database 206 explained with reference to FIG. 3) configured to store digital wallet account information for a plurality of users. If no match between records stored in the database and personal contact information provided by the online merchant 904 is found, it is determined that a record of digital wallet account for the user 902 does not exist in the database associated with the server system 906. Alternatively, if a match between a record stored in the database and personal contact information provided by the online merchant 904 is found, it is determined that a record of the digital wallet account for the user 902 exists in the database associated with the server system 906.

At 916, the server system 906 communicates the result of the determination to the online merchant 904. At 918, the online merchant 904 displays payment options to the user 902 in response to the initiation of the checkout process by the user 902. An option to pay using a digital wallet account may be displayed to the user 902 in addition to options for payments using a credit/debit card or using net banking as shown in FIG. 5A. It is noted that the option to pay using a digital wallet may be configured to display a payment card number in a masked format if it is determined that a record of the digital wallet account exists for the user in the server system 906. However, if no record of the digital wallet account exists for the user then the option to pay using a digital wallet account may not display any payment card number as shown in FIG. 5A.

At 920, the user 902 provides payment card information along with user consent to the online merchant 904. The user consent is provided to add the corresponding payment card to a digital wallet account. In at least some embodiments, the user consent is indicative of the user's interest in creating a digital wallet account. In some embodiments, the user 902 may already be associated with a digital wallet account and the digital wallet based payment option may display a payment card number in a masked format to the user 902. However, the user 902 may choose to use a different payment card not included within the digital wallet account to complete the online purchase transaction. Accordingly, in spite of being associated with a digital wallet account, the user 902 may provide payment card information along with consent to add the corresponding payment card to the digital wallet account. The provisioning of the payment card information and the consent may be performed as explained in FIG. 5B and is not explained again herein. At 922, the online merchant provisions the payment card information along with the user consent to the server system 906.

At 924, the server system 906 creates a digital wallet account and adds the payment card information to the created digital wallet account if no record of the digital wallet account exists for the user 902. The digital wallet account may be created using personal contact information as explained with reference to FIGS. 5B to 7. If a record of the digital wallet account exists for the user 902 in the database 906, then at 924, the server system 906 adds the payment card information to the digital wallet account subsequent to successful user authentication.

At 926, the server system 906 provisions the full primary account number (PAN) to the online merchant 904 to initiate authorization of the financial transaction. At 928, the online merchant 904 provisions the PAN to the acquirer 908 to complete the authorization process with the issuer of the payment card. Upon successful authorization, the acquirer 908 communicates the result to the online merchant 904 at 930. The online merchant 932 generates a transaction id and provides an item delivery date along with the transaction id to the user 902 to complete the online purchase transaction at 932. The sequence flow diagram 900 ends at 932.

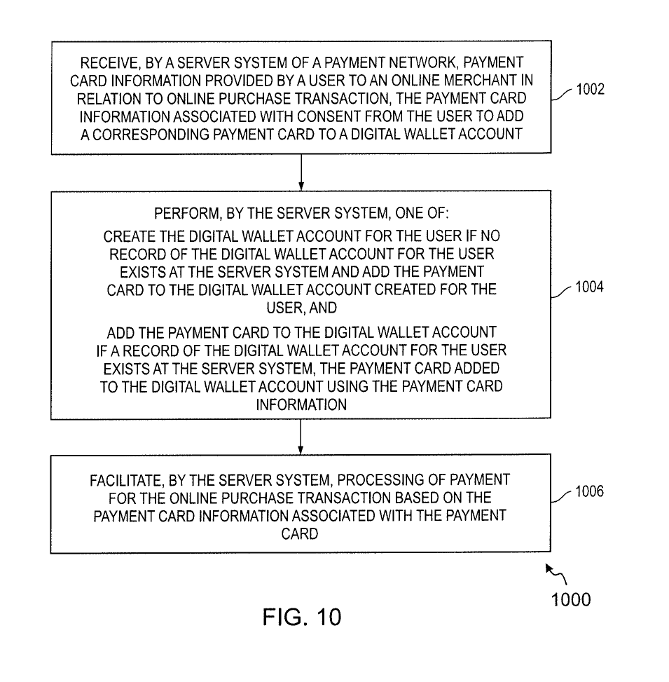

FIG. 10 is a flow diagram of an example method 1000 for facilitating digital wallet based payment transactions, in accordance with one embodiment of the present invention. The method 1000 depicted in the flow diagram may be executed by, for example, the server system 202 explained with reference to FIGS. 2 to 8. Operations of the flowchart, and combinations of operation in the flowchart, may be implemented by, for example, hardware, firmware, a processor, circuitry and/or a different device associated with the execution of software that includes one or more computer program instructions. The operations of the method 1000 are described herein with help of the server system 202. It is noted that the operations of the method 1000 can be described and/or practiced by using a system other than the server system 202. The method 1000 starts at operation 1002.

At operation 1002, payment card information provided by a user to an online merchant in relation to online purchase transaction is received. The payment card information is associated with consent from the user to add a corresponding payment card to a digital wallet account. As explained with reference to FIG. 5A, a merchant application, such as for example a Website or a mobile application, may display several items for purchase to a user. The user may select at least one item offered for purchase and initiate the checkout process, i.e. provide an indication to make payment for the one or more items selected for purchase. In at least some embodiments, the user may have created an account with the online merchant and provided personal contact information such as shipping information, phone number and/or Email address to the online merchant. Upon user initiation of the checkout process, the merchant application may be configured to provision the personal contact information to a server system, such as the server system 202 of the payment network to determine if the user is associated with a digital wallet account or not. The server system may determine if a record of the digital wallet account exists for the user or not and communicate the result to the merchant application. Accordingly, the online merchant application may be configured to display payment options to the user. The display of payment options is shown in FIG. 5A. If it is determined that the record of the digital wallet account exists for the user at the server system, then the merchant application may be configured to display a digital wallet based payment option showing a payment card number in a masked format to the user as shown using option 802 in FIG. 8. If it is determined that the record of the digital wallet account does not exist for the user at the server system, then the online merchant application may be configured to display a digital wallet based payment option without any payment card number, such as option 502 shown in FIG. 5A.

In an example scenario, the user may choose to pay using a payment card and accordingly enter a payment card information, such as a payment card number, a payment card expiry details, a name displayed on the payment card, a CVC2 number. Such information entered by the user configures the payment card information. The user may also provide consent to add a payment card corresponding to the payment card information in a digital wallet account. In one embodiment, the user may select a check box, such as the consent box 562, to provide an indication to add the corresponding payment card to the digital wallet account.

At operation 1004, at least one of (1) creating a digital wallet account and adding the payment card to the digital wallet account; and (2) adding the payment card to the digital wallet account is performed. More specifically, if no record of the digital wallet account exists for the user at the server system, then a digital wallet account is created for the user. In one embodiment, the digital wallet account may be created for the user by the server system based on the personal contact information. The user may be provisioned a password-reset link to reset the password and activate the created digital wallet account and thereafter a personal identity may be authenticated prior to adding the payment card to the created digital wallet account as explained with reference to FIGS. 6 and 7. If a record of the digital wallet account already exists at the server system, then the payment card may be added to the digital wallet account upon successful authentication of the user.

At operation 1006, processing of payment for the online purchase transaction is facilitated based on the payment card information associated with the payment card. More specifically, the server system may be caused to communicate the successful authentication of the user to the merchant application and in some cases, share the full primary account number (PAN) with the merchant application, which may then provision this information to the acquirer (i.e. banking institution associated with the merchant). The acquirer may communicate with the issuer of the payment card to authorize the payment card transaction. The authorization of the payment card transaction for processing the payment card transaction may be performed as explained with reference to FIG. 7 and is not explained again herein. The method 1000 ends at operation 1006.

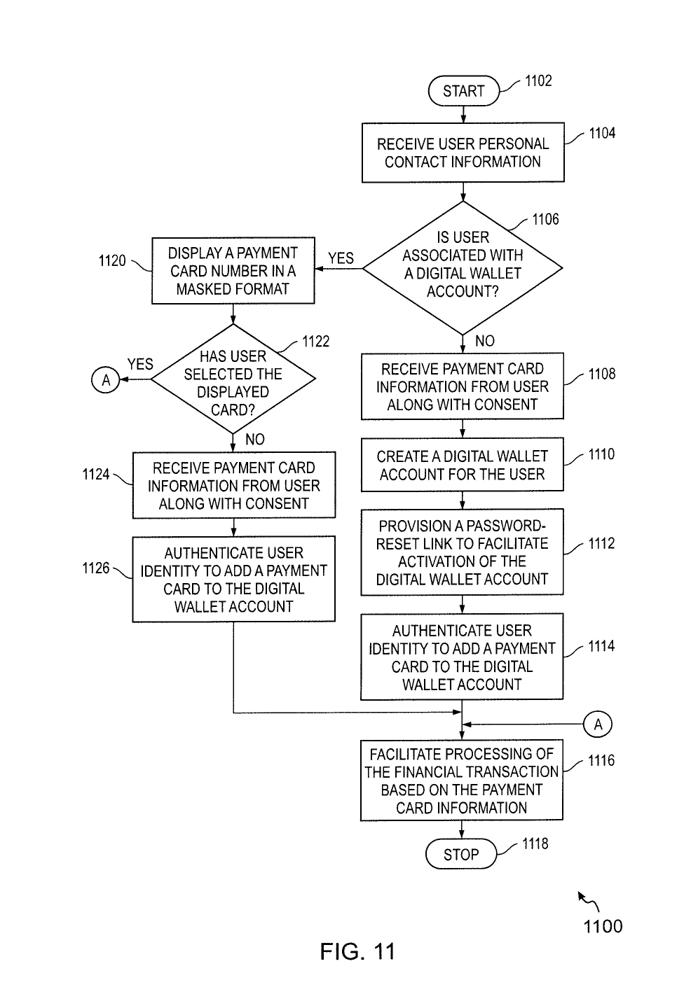

FIG. 11 is a flow diagram of an example method 1100 for facilitating digital wallet based payment transactions, in accordance with another embodiment of the present invention. The method 1100 depicted in the flow diagram may be executed by a processor in any computing device (such as for example, the processor 302 of the server system 202) configured to include machine instructions for facilitating digital wallet based payment transactions as explained with reference to FIGS. 2 to 8. The method 1100 starts at operation 1102. At operation 1102, the user initiates a check out process for online purchase of an item.

At operation 1104, personal contact information of a user is received from the merchant application. At operation 1106, it is determined whether the user is associated with a digital wallet account. The determination is performed based on the personal contact information.

If it is determined that no record of a digital wallet account exists for the user, then at operation 1108, payment card information is received from the user along with consent to add corresponding payment card to a digital wallet account. At operation 1110, a digital wallet account is created for the user based on the personal contact information. At operation 1112, a password-reset link is provided to the user to reset the password and activate the created digital wallet account. At operation 1114, user identity is authenticated to add payment card to the digital wallet account subsequent to successful activation of the digital wallet account. At operation 1116, the processing of the financial transaction is facilitated based on the payment card information. The processing of the financial transaction may involve provisioning of the primary account number to payment card issuer to authorize the payment card transaction. The method 1100 ends at operation 1118. At operation 1118, the online merchant may provision a confirmation of the completion of the financial transaction along with a transaction reference number to the user.

If it is determined that a record of a digital wallet account exists for the user, then at operation 1120, a digital wallet based payment option showing a payment card number in masked format is displayed to the user by the online merchant application. At 1122, it is determined whether the user has selected the displayed payment card for the purchase transaction. If the user has selected the payment card for the purchase transaction, then operations 1116 and 1118 are performed to facilitate processing of the financial transaction. If the user selects to use a different payment card than the payment cards included within the user's digital wallet account, then payment card information is received from the user along with user consent for adding the corresponding payment card to the digital wallet account at operation 1124 and the user identity is authenticated at operation 1126. Thereafter, 1116 and 1118 are performed to facilitate processing of the payment card transaction.

The disclosed methods 1000 and 1100 or one or more operations of the methods 1000 and 1100 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Various example embodiments offer, among other benefits, techniques for efficiently facilitating payments for items delivered at delivered locations. The methods and system disclosed herein enable users to make digital wallet based payment transactions. A user may create a digital wallet account or add a payment card to an existing digital wallet account during the ongoing online purchase transaction itself by providing the payment card information and consent to add the payment card information to the digital wallet account during an online checkout process. Such creation of the digital wallet account and addition of a banking card to the digital wallet account precludes cumbersome effort on part of the user to intentionally sign-up for an account on the Website or the online portal of the digital wallet service provider.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the systems and methods may be embodied using transistors, logic gates, and electrical circuits (for example, application specific integrated circuit (ASIC) circuitry and/or in Digital Signal Processor (DSP) circuitry).

Particularly, the server system 202 and its various components such as the computer system 204 and the database 206 may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or computer to perform one or more operations (for example, operations explained herein with reference to FIGS. 10-11). A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Various embodiments of the invention, as discussed above, may be practiced with steps and/or operations in a different order, and/or with hardware elements in configurations, which are different than those which, are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

1. A computer-implemented method, comprising:
receiving, by a server system of a payment network, payment card information provided by a user to an online merchant in relation to online purchase transaction, the payment card information associated with consent from the user to add a corresponding payment card to a digital wallet account;
performing, by the server system, one of:
creating the digital wallet account for the user if no record of the digital wallet account for the user exists at the server system and adding the payment card to the digital wallet account created for the user, and
adding the payment card to the digital wallet account if a record of the digital wallet account for the user exists at the server system, the payment card added to the digital wallet account using the payment card information; and
facilitating, by the server system, processing of payment for the online purchase transaction based on the payment card information associated with the payment card.

2. The method as claimed in claim 1, further comprising:
receiving, by the server system, personal contact information related to the user from the online merchant, the personal contact information provided by the user prior to the provisioning of the payment card information; and
determining, by the server system, if the record of the digital wallet account for the user exists at the server system based on the personal contact information.

3. The method as claimed in claim 2, wherein the personal contact information comprises at least one of an electronic mail (Email) address, a phone number and a shipping address associated with the user.

4. The method as claimed in claim 2, wherein the personal contact information is used by the server system to create the digital wallet account for the user if no record of the digital wallet account exists for the user at the server system.

5. The method as claimed in claim 4, further comprising:
provisioning, by the server system, a password-reset link to the user by using the personal contact information of the user, the password-reset link configured to facilitate activation of the created digital wallet account.

6. The method as claimed in claim 5, further comprising:
causing, by the server system, authentication of the user subsequent to the activation of the created digital wallet account to facilitate addition of the payment card to the digital wallet account, wherein the payment card is added to the digital wallet account using the payment card information.

7. The method as claimed in claim 1, further comprising:
causing, by the server system, display of at least one payment card number associated with the digital wallet account if the record of the digital wallet account for the user exists at the server system, wherein each payment card number from among the at least one payment card number is displayed in a masked format.

8. The method as claimed in claim 7, wherein the user provides the payment card information for the payment card if a payment card number of the payment card chosen for the online purchase transaction by the user is not displayed among the at least one payment card number associated with the digital wallet account.

9. The method as claimed in claim 8, further comprising:
causing, by the server system, authentication of the user to facilitate addition of the payment card to the digital wallet account.

10. The method as claimed in claim 9, wherein the online merchant is configured to perform authorization of the online purchase transaction subsequent to the successful authentication of the user, and wherein the authorization is performed using the payment card information associated with the payment card.

11. The method as claimed in claim 1, further comprising:
causing, by the server system, display of payment card number of the payment card in a masked format to the user upon selection of a digital wallet payment option by the user during checkout for a subsequent online purchase transaction.

12. The method as claimed in claim 11, further comprising:
provisioning, by the server system, full primary account number (PAN) associated with the payment card to the online merchant subsequent to the selection of the payment card for the subsequent online purchase transaction, wherein the full PAN is provided to the online merchant to facilitate authorization of the subsequent online purchase transaction by the online merchant.

13. A server system associated with a payment network, the server system comprising:
a database configured to store digital wallet accounts for a plurality of users, each digital wallet account comprising information related to one or more payment cards associated with a respective user, each payment card from among the one or more payment cards capable of facilitating at least one financial transaction; and
a computer system in operative communication with the database, the computer system comprising:
a communication interface configured to receive payment card information provided by a user to an online merchant in relation to online purchase transaction, the payment card information associated with consent from the user to add a corresponding payment card to a digital wallet account; and
a processor in operative communication with the communication interface, the processor configured to:
perform one of:
create the digital wallet account for the user if no record of the digital wallet account for the user exists at the server system and add the payment card to the digital wallet account created for the user, and
add the payment card to the digital wallet account if a record of the digital wallet account for the user exists at the server system, the payment card added to the digital wallet account using the payment card information; and
facilitate processing of payment for the online purchase transaction based on the payment card information associated with the payment card.

14. The server system as claimed in claim 13, wherein the processor is further configured to:
receive personal contact information related to the user from the online merchant, the personal contact information provided by the user prior to the provisioning of the payment card information; and
determine if the record of the digital wallet account for the user exists in the database based on the personal contact information.

15. The server system as claimed in claim 14, wherein the personal contact information is used by the processor to create the digital wallet account for the user if no record of the digital wallet account exists for the user in the database.

16. The server system as claimed in claim 15, wherein the processor is further configured to:
provision a password-reset link to the user by using the personal contact information of the user, the password-reset link configured to facilitate activation of the created digital wallet account; and
cause authentication of the user subsequent to the activation of the created digital wallet account to facilitate addition of the payment card to the digital wallet account.

17. The server system as claimed in claim 13, wherein the processor is further configured to:
cause display of at least one payment card number associated with the digital wallet account if the record of the digital wallet account for the user exists in the database, wherein each payment card number from among the at least one payment card number is displayed in a masked format, and wherein the user provides the payment card information for the payment card if a payment card number of the payment card chosen for the online purchase transaction by the user is not displayed among the at least one payment card associated with the digital wallet account.

18. The server system as claimed in claim 13, wherein the processor is further configured to:
cause authentication of the user to facilitate addition of the payment card to the digital wallet account and, wherein the online merchant is configured to perform authorization of the online purchase transaction subsequent to the successful authentication of the user, and wherein the authorization is performed using the payment card information associated with the payment card.

19. A computer-implemented method comprising:
receiving, by a processor, personal contact information related to a user from an online merchant, the user engaged in an online purchase transaction with the online merchant;
using the personal contact information, determining by the processor, if a record of the digital wallet account for the user exists in a database;
receiving, by the processor, payment card information provided by the user to the online merchant in relation to the online purchase transaction, the payment card information associated with consent from the user to add a corresponding payment card to the digital wallet account;
creating the digital wallet account for the user by the processor if no record of the digital wallet account for the user exists in the database;
facilitating, by the processor, user activation of the digital wallet account using the personal contact information; and
subsequent to activation of the digital wallet account, adding the payment card to the digital wallet account by the processor upon successful user authentication, the payment card added to the digital wallet account using the payment card information, wherein processing of payment for the online purchase transaction is performed based on the payment card information associated with the payment card.

20. The method as claimed in claim 19, further comprising:
adding the payment card to the digital wallet account by the processor if the record of the digital wallet account exists in the database and the digital wallet account does not comprise the payment card associated with the payment card information.
